(19) United States
(12) Patent Application Publication
(10) Pub. No.: US 2005/0259290 A1
(43) Pub. Date: Nov. 24, 2005

(54) Selectively printing documents at a central printing location with or without privacy protection

(76) Inventors: Antonio Tijerino, Eagle, ID (US); Chad Atkinson, Eagle, ID (US); James M. Murphy, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/850,306

(22) Filed: May 20, 2004

(51) Int. Cl. G06F 3/12; H04L 9/32; G08B 29/00

(52) U.S. Cl. 358/1.14; 340/5.21; 340/5.24

(57) ABSTRACT

Systems and methods are described according to the present invention by which users operating in an arrangement wherein all documents to be printed are sent to a central print station remote from the users and their computers. The invention permits a user in such an environment to determine whether a document desired to be printed may be accorded and maintained as a private document or not. If the job is not “private”, the remote printer proceeds to print the job. If the job is “private”, a unique privacy token is generated at the user's computer and made available to the user. The print job goes into a special queue and the user goes to the printer at the central print station and checks to see whether his particular job is displayed on the printer panel. If so, the user enters the privacy token PIN on the printer keyboard and the printer initiates processing of the job while the user is present, thus assuring the privacy nature of the document.

### BACKGROUND

This invention relates to the printing of documents including text and visual images in accordance with digitally recorded data. The most common printers capable of reproducing such documents from recorded data are laser and inkjet printers. The data to be printed is usually derived from data bases residing in a computer. It has been common to provide a printer for each computer but in a business office environment, such a one-on-one arrangement has proven to be costly since most employees are each provided with a personal computer particularly where it is desirable to provide all employees in a business office with the capability of communicating with others via the internet or by going on line internally. As noted, to provide each user in such an environment with a printer in order to permit production of a paper copy or document is not only costly but highly inefficient since most users only need to occasionally print documents. Hence, the printer with each computer may only be called upon by its user to produce a document for a small percentage of the time during the average workday. Therefore, many businesses have established print centers comprising one or more printers to which many of the computers in the workplace are connected. The user then goes to the print center to obtain a copy of the document which has been created or resides on a personal computer. This arrangement is exceptionally cost-effective and highly efficient. However, documents thus produced in the print center may be available to any user. Obviously, certain users may desire to keep the document and its contents private and unavailable to other unauthorized users. Such information may be personnel related or payroll material or relate to highly confidential business or technical matters identified hereinafter referred to as “private” documents or data. Government and military facilities which may generate a host of documents for restricted (“Eyes Only”) recipients would tend to stay away from workgroup printers where there is no assurance of privacy, security or confidentiality. In such environments the preference is to ensure that no one but the intended recipient or audience receives a copy of a sensitive document. In facilities employing a central or workgroup printer capability, it is also possible that valuable documents, generated after days or weeks of effort, might be inadvertently removed and lost by others using the printer facility, often with no means for identifying the owner of the document. The present invention provides a means for making documents, when printed in a printer center, only available to the user-creator of the document or authorized individuals.

There have been proposals in the prior art to solve this problem. Thus, in U.S. Pat. No. 5,970,218 it is proposed that the user enters his PIN once he has selected the private print option and the user is identified. The user than goes to the printer and enters the PIN at the printer panel whereupon the document is printed. In U.S. Pat. No. 6,307,640 a job number and a password are generated and the user takes both pieces of information to the printer to retrieve the job. It has also been proposed to utilize printers with special output trays having limited access or maintaining printers in locked rooms with restricted access or provide a sensitive document with a cover sheet indicating privacy or confidentiality. Usually, however, the user's most practical solution is simply to go to the central printer and wait for the print job.

### SUMMARY

According to the present invention systems and methods are provided by which the user initially opens the printer driver dialog box on his or her computer and selects the “Print Document” command. Upon prompting by printer driver, the user indicates if the document is “private” or not. If the job is not “private”, the printer proceeds to print the job . If the job is “private”, a PIN is generated by the driver and displayed to the user for later use at the printer. The job goes into a special queue and the user goes to the printer and checks to see whether his particular job is displayed on the printer panel. If so, the user enters the PIN on the printer keyboard and the printer initiates processing of the job while the user is present.

### BRIEF DESCRIPTION OF THE DRAWINGS

The disclosed systems and methods can be better understood with reference to the following drawings. The components in the drawings are not necessarily to scale.

FIG. 1 is an illustration of an embodiment of a computing/printing system environment with a plurality of computers coupled to a printer.

FIG. 2 is a flow diagram of a method for identifying a print job as “private” and then printing or providing a copy of the job only when the authorized user is present at the printer according to one embodiment of the invention.

FIG. 3 is an illustration of a printer driver dialog box suitable for use in the practice of the invention.

### DETAILED DESCRIPTION

Disclosed herein are embodiments of systems and methods for implementing printing of selected documents while providing or assuring privacy of a document at the election of a user according to the invention. Although particular embodiments are disclosed, these embodiments are provided for purposes of example only to facilitate description of the disclosed systems and methods. The description that follows herein is presented largely in terms of processes and symbolic representations of operations performed by conventional computers and peripheral devices such as printers and the like.

The computers and printers to which the invention is applicable may advantageously contain program logic or other equivalents representing data and instructions, which cause the computers and printers to operate in a specific and predefined manner. The program logic may be advantageously implemented as one or more modules which may be configured to reside in or on the memory of the computers and/or printers for execution on one or more of the processors included in the computers or printers. These modules may include, but are not limited to, software, firmware or hardware components that cause the performance of certain tasks. It should be understood that manipulations within processors are often described in terms of machine actions caused to be performed by the processor such as adding, processing, comparing, retrieving, printing, playing, moving, searching, transmitting, and the like. It should also be understood that the programs, modules, processes, methods and the like described here are exemplary implementations and are not related or limited to any particular computer, apparatus or computer language. Various types of general purpose computing machines, printers or devices may be used according to the teachings of the invention described herein.

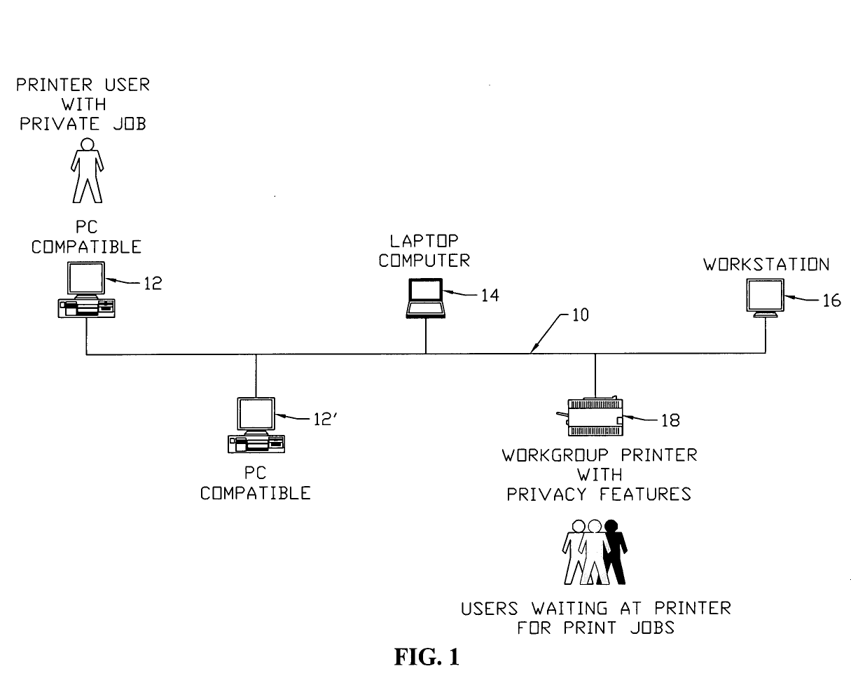

FIG. 1 illustrates a typical printing environment or system 10 for use with the invention. The system 10 may include a plurality of desktop computers 12, 12′, one or more laptop computers 14, and a workstation 16. Also provided is at least one printer 18 adapted to permit printing of any document from any of the computers in the system. The printer 18 may be provided at a central location remote from the various computers shown. The printer 18 may be any type of printer capable of selectively printing in black and white (monochrome) or color. Typically such printers include inkjet printers, laser printer, thermal printers, dot matrix printers, or the like. The printer is a shared Workgroup class printer meaning a printer that is capable of being shared by a group of users and it is provided with a numeric keypad and a display screen. The printer driver must be capable of running on the Windows Operating system such as Windows 98, Windows 2000, Windows XP and new versions of the OS (Operating System). Also support for printer driver in other operating systems such as Linux and Mac OS could be provided. The printer firmware would be enhanced or modified to allow the firmware to receive print jobs from users and determine if the print job has the “privacy” flag enabled. If so then the print job would go into a special queue and the job would be displayed on the display panel for user to know his “privacy” job was waiting to be printed. The computers 12-14 also include keyboards (not shown) and pointing devices (i.e., a mouse) for entering text data and/or user commands, and for causing the performance of operations by or upon objects symbolically displayed on the monitor of a computer. The computers 12-14 may also include computer-readable memory media (not shown) such as a hard disk mounted on a hard disk drive (also not shown). The hard disk may store application programs such as Microsoft Word, Excel, Power Point, Adobe Acrobat and Page Maker. By such stored application programs the computer may generate, manipulate, and store files, data, documents, drawings, photographs in digital electronic form and display such stored data on the monitor associated therewith and/or provide for the printing of such data in these files. Auxiliary device drivers may also be stored on the computer's hard disk including a printer driver that generates computer-executable process steps according to the present invention. The printer driver provides a software interface to firmware in the printer to enable and facilitate the transfer of data between the computers 12-14 and the printer 18. Communication between the computers and the central print station may be provided via a computer bus or network 20. The network 20 may comprise a single network, such as a local area network (LAN), or a collection of networks (LANs and/or wide area networks (WANs)) that are communicatively coupled to each other. In some embodiments, the network 110 may comprise part of the Internet.

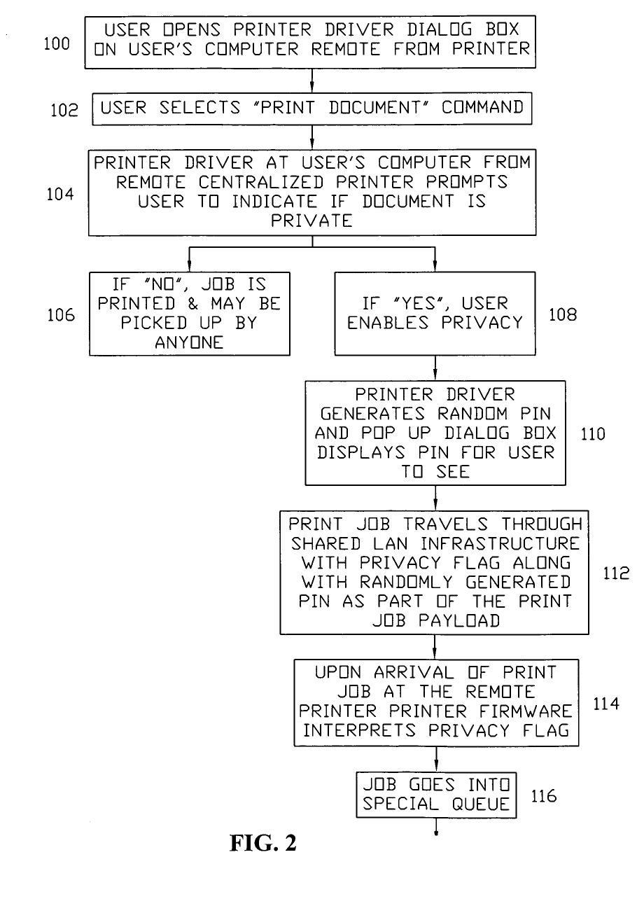

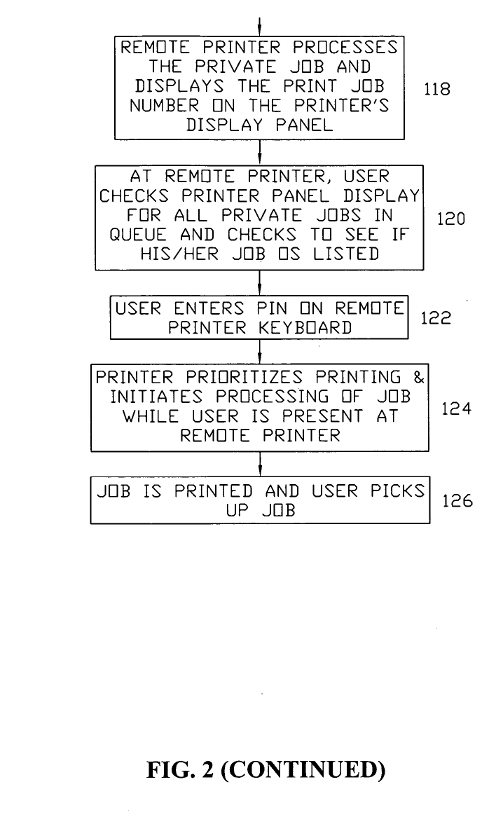

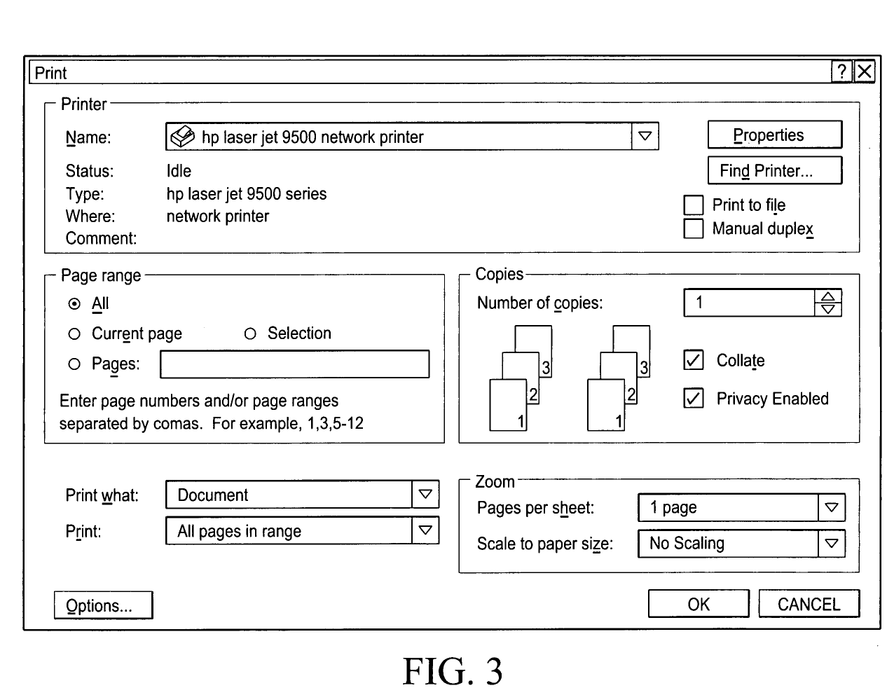

With reference to FIGS. 1 and 2, it will be appreciated that most window application programs, like Microsoft Word*, make a print function available to print a particular text file, image file or other type of data. This function is usually initiated by the user using the keyboard or most likely a pointing device so as to place the cursor on an icon on the monitor, the icon representing a printer and then “clicking” (usually depressing the left button on the mouse or pointing device). The application program then presents a dialog box or print window 30 as shown in FIG. 3, on the computer monitor to permit selection of a number of features desired to be provided in the printing of a document, for example. These features may include the number of copies to be printed; the name of the document, the number of copies to be printed; the model, type and location of the printer; the print style; the page setup; whether the copies are to collated; and finally whether the document and copies are to be maintained in privacy.

Referring now to FIG. 2, the steps of a method for initiating the printing of a document and providing for maintaining the document in privacy (that is, available for viewing by only authorized personnel) is shown. In Step 100 the user, at his or her computer, opens the printer dialog box which is remotely located on a printer in a centralized printing station and is visible on the user's computer monitor. In Step 102 the user selects the “Print Document” command which, in Step 104, causes the printer driver to ask the user to indicate whether the document is to be maintained in privacy. If, in Step 106, the user indicates that privacy is not necessary or desired, the printer immediately proceeds to print the document and the printed copy may be picked up at the central print station. If however, privacy is desired and the user so indicates, printing and maintenance of the document in privacy (Step 108) is enabled whereupon a random token or “PIN” (Personal Identification Number) is generated (Step 110). The token or PIN is sent along with and as part of the print job to the remote printer along with the privacy flag. (Step 112). The printer firmware thereupon interprets the “privacy” flag (Step 114) and the print job goes into a special queue (Step 116). The printer firmware extracts print job information and might include the user's information (i.e., MS Domain information), and the token/PIN for the job). The printer processes the private job and displays the print job number on the printer's display panel (Step 118). The user or other authorized person then proceeds to the central print station and checks the panel display on the printer to see what private jobs are in the queue, Step 120, and ready for printing. The user then enters his or her token or PIN on the keyboard of the remote printer, Step 122. The printer thereupon prioritizes printing and initiates processing of the job while the user is present at the remote printer, Step 124. In Step 126 the job is then picked up by the user and the process is completed.

1. A system for printing documents at a print center from data bases remotely located from said print center, there being at least one printer at said print center having privacy features and connected to at least one computer containing said data bases, said computer having means to identify documents with a privacy designation and to make said privacy designation in the print job data as a part thereof which is forwarded to said printer at said print center upon command by said user, and a communication network for transferring said print job data to said printer whereupon entry of said privacy designation by said user at said printer causes said printer to print out a document having said privacy designation.

2. A method for printing documents at a print center having one or more printers thereat remotely located from one or more computers connected to said print center, comprising selectively designating a document as private and assigning a privacy token to said document, obtaining said privacy token from the computer containing the data base for said document, forwarding said privacy token into a printer at said print center and printing out said document in response thereto.

3. The method according to claim 2 wherein data identifying print jobs awaiting printing at said print center is display, maintaining privacy-designated documents in a predetermined queue, said documents being only accessible for printing upon entry of the appropriate privacy token, entering said privacy token into said printer, and printing said document.

4. The method according to claim 3 wherein the step of selectively designating a document as private and assigning a privacy token to said document is accomplished by opening the dialog box for said printer and enabling the privacy activation operating to assign and provide a unique privacy token for said document.

5. The method according to claim 2 including the step of requesting a document to be printed, and then indicating whether said document is private or non-private.

6. The method according to claim 2 wherein the printer driver prompts the user to designate the selected document as a document for which privacy is desired.

7. The method according to claim 6 wherein the privacy enable function is activated when said document is identified as a document for which privacy is desired.

8. The method of claim 6 where said printer driver generates a privacy token in response to the activation of said privacy enable function.

9. The method of claim 8 wherein said privacy token is displayed to the user at said computer.

10. The method according to claim 8 wherein said print job is sent to said printer with said privacy token as a part of the print job data for said document.

11. The method according to claim 2 wherein all print jobs that are private are displayed at said printer and are maintained in a special queue.

12. The method according to claim 11 wherein the use enters the privacy token received at said computer into said printer.

13. The method according to claim 12 wherein entry of said privacy token into said printer initiates the printing of said document.
